(19) United States
(12) Patent Application Publication
(10) Pub. No.: US 2018/0036738 A1
(43) Pub. Date: Feb. 8, 2018

(54) MILL

(71) Applicant: WUHAN KAIDI ENGINEERING TECHNOLOGY RESEARCH INSTITUTE CO., LTD., Wuhan (CN)

(72) Inventors: Ninggang TAN, Wuhan (CN); Xiangshan NIU, Wuhan (CN); Yong ZHANG, Wuhan (CN)

(21) Appl. No.: 15/784,215

(22) Filed: Oct. 16, 2017

Related U.S. Application Data
(63) Continuation-in-part of application No. PCT/CN2016/079379, filed on Apr. 15, 2016.

(30) Foreign Application Priority Data
Apr. 17, 2015 (CN) 201510184107.0

(51) Int. Cl. B02C 7/08; B02C 7/11

(52) U.S. Cl. CPC B02C 7/08; B02C 7/11; B02C 2210/02

(57) ABSTRACT

A mill including a mill body including a feeding pipe and a discharging pipe; a motor; and a vessel including a feeding port, a discharging port, and a supporting base. The vessel is disposed outside the mill body, and a sealing space is formed between the vessel and the mill body. The feeding port is disposed on the outer wall of the upper part of the vessel and is in a seal-tight connection with the feeding pipe of the mill body through a soft feeding joint, and the discharging port is disposed on the outer wall of the lower part of the vessel and is in seal-tight connection with the discharging pipe of the mill body through a soft discharging joint. The supporting base is disposed at the bottom of the vessel, and the mill body is installed on the supporting base via a cushion pad.

### CROSS-REFERENCE TO RELATED APPLICATIONS

This application is a continuation-in-part of International Patent Application No. PCT/CN2016/079379 with an international filing date of Apr. 15, 2016, designating the United States, now pending, and further claims foreign priority to Chinese Patent Application No. 201510184107.0 filed Apr. 17, 2015. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND OF THE INVENTION

### Field of the Invention

The present disclosure relates to a mill.

### Description of the Related Art

Conventional mills generally operate under normal pressure and do meet the requirement for operation in high-pressure conditions.

### SUMMARY OF THE INVENTION

It is one objective of the invention to provide a mill adapted for operation in high-pressure conditions.

To achieve the above objectives, in accordance with one embodiment of the invention, there is provided a mill comprising a mill body and a motor, in which a vessel is disposed outside the mill body, and a sealing space is formed between the high-pressure vessel and the mill body; a feeding port is provided on an outer wall of an upper part of the high-pressure vessel, the feeding port is in a seal-tight connection with a feeding pipe of the mill body through a soft feeding joint, a discharging port is provided on an outer wall of a lower part of the high-pressure vessel, the discharging port is in a seal-tight connection with a discharging pipe of the mill body through a soft discharging joint, a supporting base is provided at the bottom of the high-pressure vessel, the mill body is installed on the supporting base by a cushion pad, a connecting shaft is inserted movably at the top of the high-pressure vessel in a sealing manner, the upper end of the connecting shaft is in a transmission connection with an output shaft of the motor, and the lower end of the connecting shaft is connected with a main shaft of the mill body; during the operation, the sealing space between the mill body and the high-pressure vessel is filled with an inert medium, and the pressure of the high-pressure inert medium is greater than or equal to the pressure in the mill body. By adding a high-pressure vessel outside the mill body, a high-pressure inert medium may be filled in the sealing space between the mill body and the high-pressure vessel to balance the internal pressure and external pressure of the mill body, thereby improving the stress environment of the mill body so that the mill body may follow the design and production requirements of the general level, greatly reducing the research and development and manufacturing costs; at the same time, by designing the pressure of the inert media filled in the high-pressure vessel to be slightly larger than the internal pressure of the mill body, the mill body thus operates under pressure, thus reducing the dust leakage and flying dust phenomenon, and reducing the environmental dust pollution; moreover, by adding a cushion pad between the mill body and the supporting base and connecting both the feeding pipe and the discharging pipe of the mill body with the feeding port and the discharging port of the high-pressure vessel by a soft joint, the mill body and the high-pressure vessel are all softly connected, so that it is possible to effectively prevent the vibration of the mill body from being transferred to the high-pressure vessel, thereby improving the stability and service life of the high-pressure vessel.

In a class of this embodiment, the lower end of the connecting shaft is connected to the main shaft of the mill body through a coupling. Of course, the main shaft of the mill body may also be lengthened and extended outside the high-pressure vessel to be in a direct transmission connection with the output shaft of the motor.

In a class of this embodiment, the base portion of the supporting base is located within the high-pressure vessel, and the leg portion of the supporting base runs through the bottom of the high-pressure vessel in a sealing manner and extends to align with legs of the high-pressure vessel. By penetrating the leg portion of the supporting base through the bottom of the high-pressure vessel in a sealing manner and extending to align with the leg of the high-pressure vessel, this greatly reduces the stress of the leg of the high-pressure vessel, thereby further improving the stability and service life of the high-pressure vessel.

In a class of this embodiment, the leg portion of the supporting base runs through the bottom of the high-pressure vessel with a bellows in a sealing manner. Of course, other sealing structures may also be used.

In a class of this embodiment, the mill body comprises a shell and an upper-layer crushing mechanism and a lower-layer milling mechanism disposed in the shell, respectively;

the upper-layer crushing mechanism comprises an upper-layer wear-resistant lining ring, a plurality of upper-layer rotating discs sequentially decreasing in diameter from the top down are laminated in the upper-layer wear-resistant lining ring, a groove for receiving a stepped structure of the upper-layer rotating discs is provided on the inner surface of the upper-layer wear-resistant lining ring, the diameter of the groove from the top down in each layer corresponds to a diameter of the upper-layer rotating disc at the corresponding position, a plurality of upper-layer guide grooves are provided corresponding to an outer edge of each of the upper-layer rotating discs, a corresponding number of upper-layer milling bodies are installed movably between two adjacent upper-layer rotating discs through the guide grooves, the masses of all the upper-layer milling bodies on the upper-layer rotating discs are sequentially decreased layer by layer from the top down, and the masses of the upper-layer milling bodies on one upper-layer rotating disc are the same;

the lower-layer milling mechanism comprises a lower-layer wear-resistant lining ring, a plurality of lower-layer rotating discs having the same diameter are laminated in the lower-layer wear-resistant lining ring, a plurality of lower-layer guide grooves are provided corresponding to an outer edge of each of the lower-layer rotating discs, respectively, a corresponding number of lower-layer milling bodies are installed movably between two adjacent lower-layer rotating discs through the lower-layer guide grooves, the masses of all the lower-layer milling bodies the same;

the upper-layer wear-resistant lining ring and the lower-layer wear-resistant lining ring are fixedly installed on the inner walls of the upper half and the lower half of the shell, respectively, the upper-layer rotating disc and the lower-layer rotating disc are fixedly installed on the main shaft of the mill body.

By designing the upper and lower parts of the mill body correspondingly as a material crushing area and a material milling area, respectively, the crushing and milling functions are integrated and the milling process is simplified; at the same time, the milling body has a vertical multi-layer layout, the milling body is large in mass at the upper part thereof and mainly has an impact effect on the material, so that a bulky material may be quickly crushed under the effect of the impact of the large-mass milling body, the milling body is small in mass and large in quantity at the lower part thereof, the material which has been impacted and crushed by the large-mass milling body in the upper layer is mainly subjected to rolling, abrasion and micro impact when passing through the material milling area of the small-mass milling body so that the material may be effectively milled to an appropriate particle size so as to achieve the requirement of a certain particle size without a sorting mechanism; moreover, by replacing the upper-layer milling body and the lower-layer milling body of different masses, the particle size of the finished milled product may be adjusted, which is easy to operate, convenient and fast; moreover, the milling body in the mill body is large in quantity and small in mass so that the milling body has a small impact on the shell, thereby reducing the vibration and noise of the mill body: finally, the groove of a stepped structure may effectively delay the falling speed of the material in the crushing zone, increasing the residence time of the material in the crushing zone, thus contributing to increasing the chance that the material is crushed and milled.

In a class of this embodiment, the upper-layer rotating disc at a lowest layer and the lower-layer rotating disc have the same diameter, and the mass of the upper-layer milling body at a lowest layer is the same as the mass of the lower-layer milling body. By designing the diameter of the upper-layer rotating disc at the bottom layer to be the same as the diameter of the lower-layer rotating disc and designing the mass of the upper-layer milling body at the bottom layer to be the same as the mass of the lower-layer milling body, the material can smoothly transfer from the material crushing area to the material milling area well.

In a class of this embodiment, the top and bottom of the shell are correspondingly provided with an upper bearing seat and a lower bearing seat, respectively, the upper end of the main shaft of the mill body is installed in the upper bearing seat through a planar thrust bearing, and the lower end of the main shaft of the mill body is installed in the lower bearing seat through a cylindrical roller self-aligning bearing. By designing the bearing at the upper end of the main shaft of the mill body as a planar thrust bearing, the planar thrust bearing may provide an axial force for the main shaft of the mill body very well, and by designing the bearing at the lower end of the main shaft of the mill body as a cylindrical roller self-aligning bearing, the cylindrical roller self-aligning bearing may effectively prevent excessive deflection of the main shaft. Thus, the combination of the planar thrust bearing and the cylindrical roller self-aligning bearing improves the working condition of the main shaft of the mill body, so that the stiffness and the strength of the main shaft of the mill body are guaranteed.

In a class of this embodiment, the upper end of the main shaft of the mill body is also installed in the upper bearing seat through a cylindrical roller bearing which is located above the planar thrust bearing. By adding a cylindrical roller bearing above the planar thrust bearing, the cylindrical roller bearing forms a three-bearing static determinate support with the plane thrust bearing and the cylindrical roller self-aligning bearing, thereby further improving the working condition of the main shaft of the mill body, so that the stiffness and the strength of the main shaft of the mill body are guaranteed better.

In a class of this embodiment, a cooler is provided outside the shell, and the cooler is a condenser. By adding a cooler outside the shell, the operating temperature of the mill body may be greatly reduced, so that the operating temperature of the mill body may be controlled within a reasonable temperature range to ensure the optimum working state of the mill body. In actual production, cold gas or cold liquid may pass through a condensing tube.

In a class of this embodiment, the side wall of the high-pressure vessel is provided with a service port. The added service port can facilitate the service and maintenance in the latter period.

In a class of this embodiment, the high-pressure vessel is sealed and assembled by the upper high-pressure vessel section and the lower high-pressure vessel section. By designing the high-pressure vessel as an assembled structure, this, on the one hand, reduces the difficulty of production of the high-pressure vessel, and, on the other hand, facilitates the installation and maintenance of the mill body.

Advantages of the mill according to embodiments of the present disclosure are summarized as follows:

1. By adding a high-pressure vessel outside the mill body, a high-pressure inert medium may be filled in the sealing space between the mill body and the high-pressure vessel to balance the internal pressure and external pressure of the mill body, thereby improving the stress environment of the mill body so that the mill body may follow the design and production requirements of the general level, greatly reducing the research and development and manufacturing costs.

2. By designing the pressure of the inert media filled in the high-pressure vessel to be slightly larger than the internal pressure of the mill body, the mill body thus operates under pressure, thus reducing the dust leakage and flying dust phenomenon, and reducing the environmental dust pollution.

3. By adding a cushion pad between the mill body and the supporting base and connecting both the feeding pipe and the discharging pipe of the mill body with the feeding port and the discharging port of the high-pressure vessel by a soft joint, the mill body and the high-pressure vessel are all softly connected, so that it is possible to effectively prevent the vibration of the mill body from being transferred to the high-pressure vessel, thereby improving the stability and service life of the high-pressure vessel;

4. By penetrating the leg portion of the supporting base through the bottom of the high-pressure vessel in a sealing manner and extending to align with the leg of the high-pressure vessel, this greatly reduces the stress of the leg of the high-pressure vessel, thereby further improving the stability and service life of the high-pressure vessel.

5. By designing the upper and lower parts of the mill body correspondingly as a material crushing area and a material milling area, respectively, the crushing and milling functions are integrated and the milling process is simplified.

6. The milling body has a vertical multi-layer layout, the milling body is large in mass at the upper part thereof and mainly has an impact effect on the material, so that a bulky material may be quickly crushed under the effect of the impact of the large-mass milling body, the milling body is small in mass and large in quantity at the lower part thereof, the material which has been impacted and crushed by the large-mass milling body in the upper layer is mainly subjected to rolling, abrasion and micro impact when passing through the material milling area of the small-mass milling body so that the material may be effectively milled to an appropriate particle size so as to achieve the requirement of a certain particle size without a sorting mechanism.

7. By replacing the upper-layer milling body and the lower-layer milling body of different masses, the particle size of the finished milled product may be adjusted, which is easy to operate, convenient and fast.

8. The milling body in the mill body is large in quantity and small in mass so that the milling body has a small impact on the shell, thereby reducing the vibration and noise of the mill body.

9. The groove of a stepped structure may effectively delay the falling speed of the material in the crushing zone, increasing the residence time of the material in the crushing zone, thus contributing to increasing the chance that the material is crushed and milled.

10. By designing the diameter of the upper-layer rotating disc at the bottom layer to be the same as the diameter of the lower-layer rotating disc and designing the mass of the upper-layer milling body at the bottom layer to be the same as the mass of the lower-layer milling body, the material can smoothly transfer from the material crushing area to the material milling area well.

11. By designing the bearing at the upper end of the main shaft of the mill body as a planar thrust bearing, the planar thrust bearing may provide an axial force for the main shaft of the mill body very well, and by designing the bearing at the lower end of the main shaft of the mill body as a cylindrical roller self-aligning bearing, the cylindrical roller self-aligning bearing may effectively prevent excessive deflection of the main shaft, and thus, the combination of the planar thrust bearing and the cylindrical roller self-aligning bearing improves the working condition of the main shaft of the mill body, so that the stiffness and the strength of the main shaft of the mill body are guaranteed.

12. By adding a cylindrical roller bearing above the planar thrust bearing, the cylindrical roller bearing forms a three-bearing static determinate support with the plane thrust bearing and the cylindrical roller self-aligning bearing, thereby further improving the working condition of the main shaft of the mill body, so that the stiffness and the strength of the main shaft of the mill body are guaranteed better.

13. By adding a cooler outside the shell, the operating temperature of the mill body may be greatly reduced, so that the operating temperature of the mill body may be controlled within a reasonable temperature range to ensure the optimum working state of the mill body.

14. The added service port can facilitate the service and maintenance in the latter period.

15. By designing the high-pressure vessel as an assembled structure, this, on the one hand, reduces the difficulty of production of the high-pressure vessel, and, on the other hand, facilitates the installation and maintenance of the mill body.

### BRIEF DESCRIPTION OF THE DRAWINGS

FIG. 1 illustrates a schematic diagram of a mill according to one embodiment of the present disclosure;

FIG. 2 illustrates a partial enlarged structure in FIG. 1;

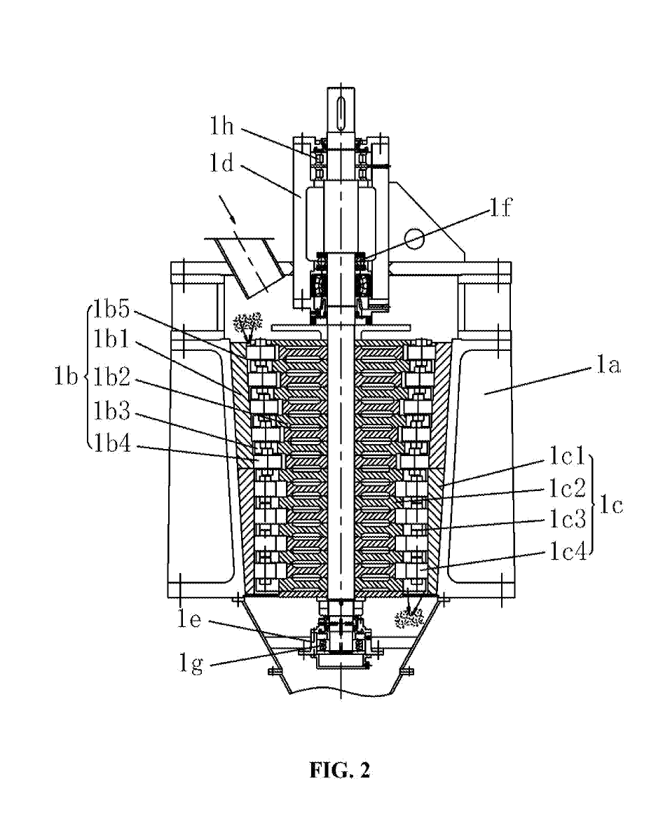

FIG. 3 illustrates an installation structure of a main shaft of a mill body of a mill according to one embodiment of the present disclosure;

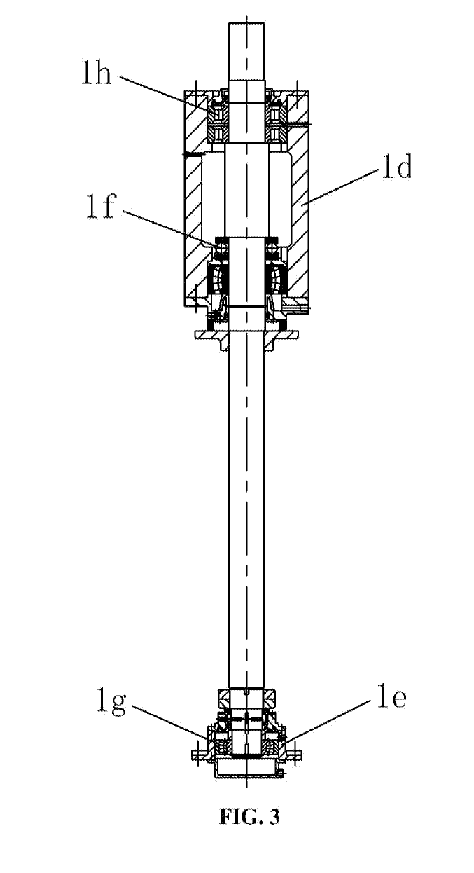

FIG. 4 illustrates a schematic diagram of an upper-layer crushing mechanism of a mill according to one embodiment of the present disclosure;

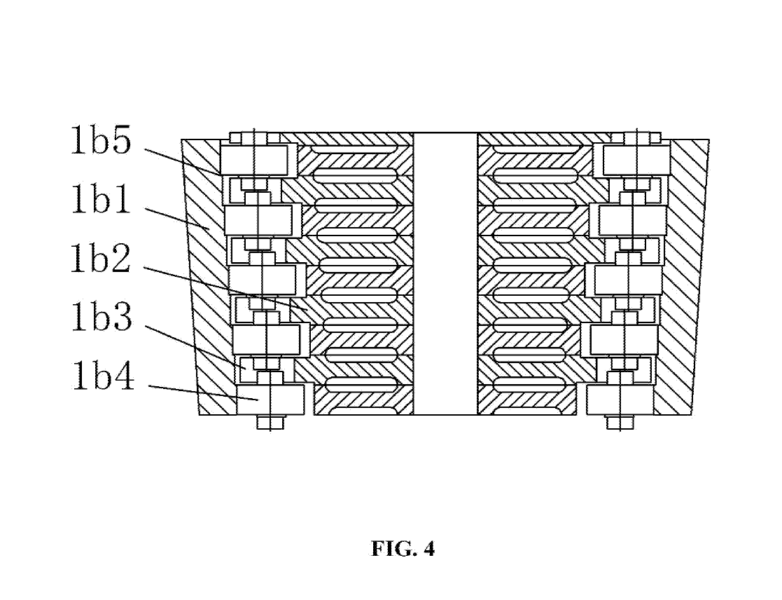

FIG. 5 illustrates a top view of a structure in FIG. 4;

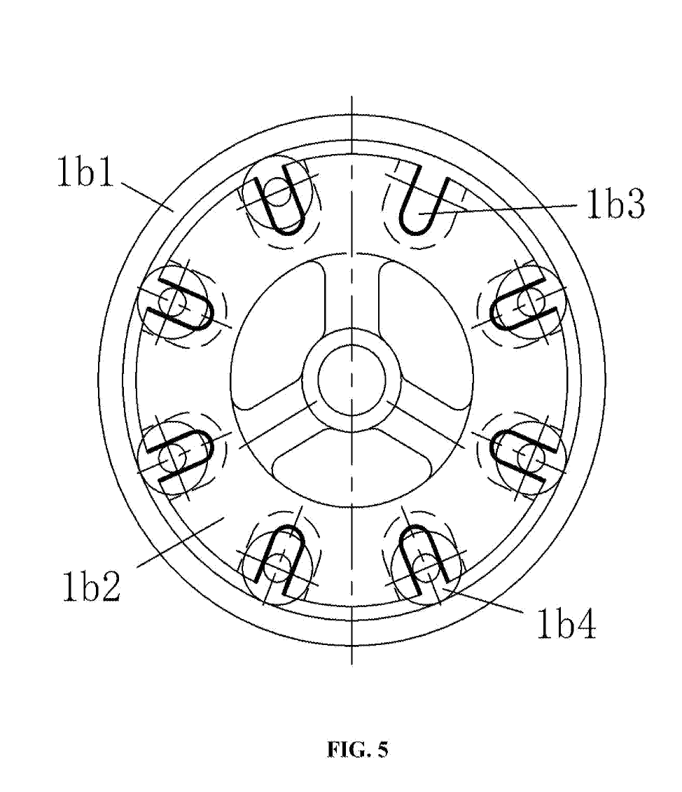

FIG. 6 illustrates a schematic diagram of a lower-layer milling mechanism of a mill according to one embodiment of the present disclosure; and

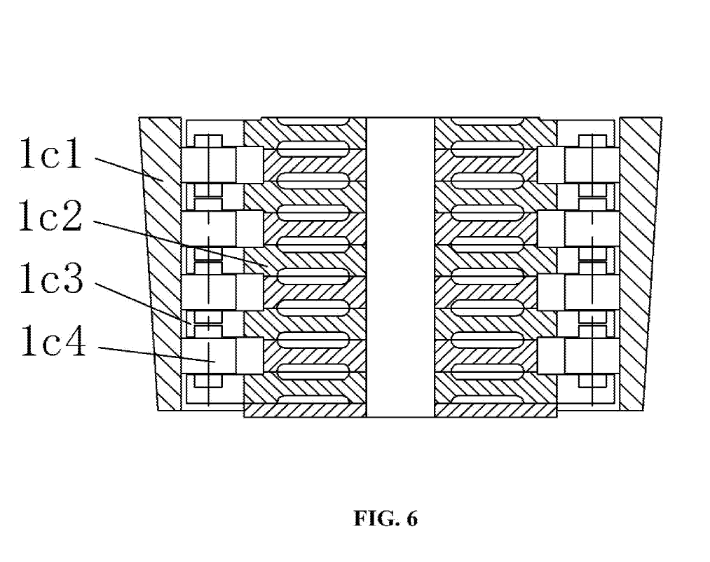

FIG. 7 illustrates a top view of a structure in FIG. 6.

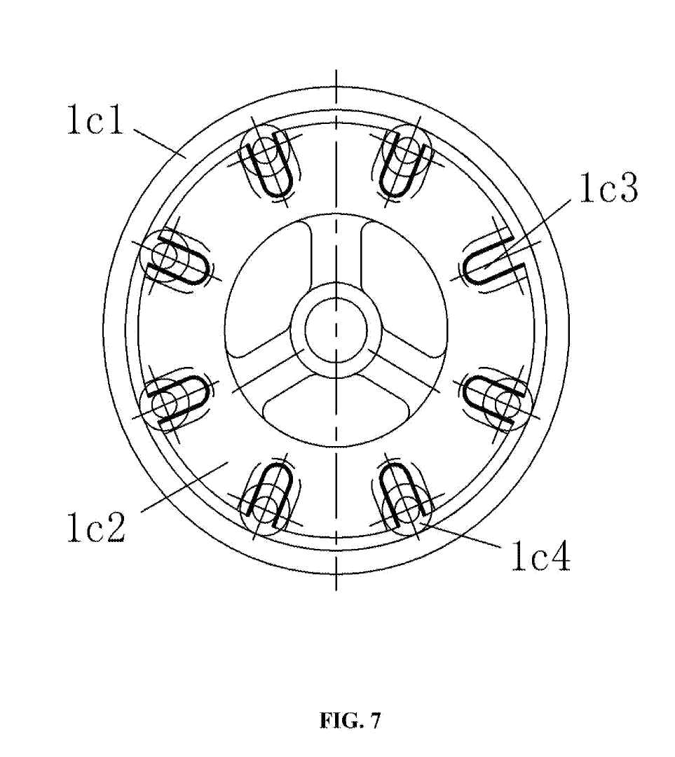

In the drawing, there is shown a main body 1, a shell 1a, an upper-layer crushing mechanism 1b, an upper-layer wear-resistant lining ring 1b1, an upper-layer rotating disc 1b2, an upper-layer guide groove 1b3, an upper-layer milling body 1b4, a groove 1b5, a lower-layer milling mechanism 1c, a lower-layer wear-resistant lining ring 1c1, a lower-upper rotating disc 1c2, a lower-upper guide groove 1c3, a lower-upper milling body 1c4, an upper bearing seat 1d, a lower bearing seat 1e, a planar thrust bearing 1f, a cylindrical roller self-aligning bearing 1g, a cylindrical roller bearing 1h, a motor 2, a high-pressure vessel 3, a feeding port 3a, a discharging port 3b, an upper high-pressure vessel section 3c, a lower high-pressure vessel section 3d, a soft feeding joint 4, a soft discharging joint 5, a supporting base 6, a cushion pad 7, a connecting shaft 8, a coupling 9, a bellows 10, a cooler 11, and a service port 12.

### DETAILED DESCRIPTION OF THE EMBODIMENTS

For further illustrating the invention, experiments detailing a mill are described hereinbelow combined with the drawings. It should be noted that the following examples are intended to describe and not to limit the invention.

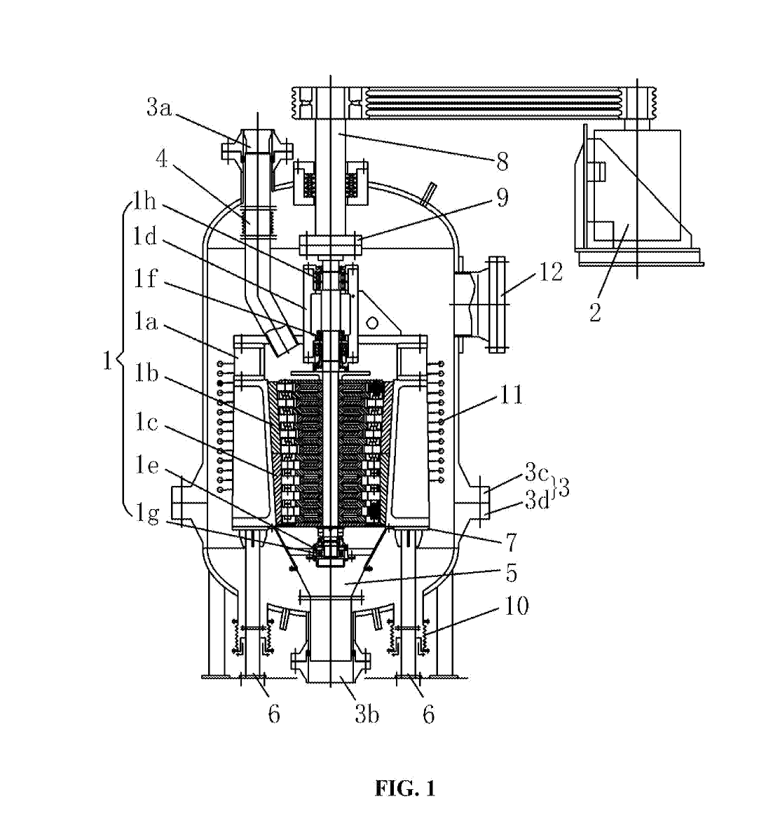

A mill shown in FIG. 1 comprises a mill body 1 and a motor 2, in which a high-pressure vessel 3 is provided outside the mill body 1, and a scaling space is formed between the high-pressure vessel 3 and the mill body 1; a feeding port 3a is provided on an outer wall of the upper part of the high-pressure vessel 3, the feeding port 3a is in a seal-tight connection with a feeding pipe of the mill body 1 through a soft feeding joint 4, a discharging port 3b is provided on an outer wall of the lower part of the high-pressure vessel 3, the discharging port 3b is in a seal-tight connection with a discharging pipe of the mill body 1 through a soft discharging joint 5, a supporting base 6 is provided at the bottom of the high-pressure vessel 3, the mill body 1 is installed on the supporting base 6 by a cushion pad 7, a connecting shaft 8 is inserted movably at the top of the high-pressure vessel 3 in a sealing manner, the upper end of the connecting shaft 8 is in a transmission connection with an output shaft of the motor 2, and the lower end of the connecting shaft 8 is connected with a main shaft of the mill body 1; during the operation, the sealing space between the mill body 1 and the high-pressure vessel 3 is filled with an inert medium, and the pressure of the high-pressure inert medium is greater than or equal to the pressure in the mill body 1. By adding a high-pressure vessel 3 outside the mill body 1, a high-pressure inert medium may be filled in the sealing space between the mill body 1 and the high-pressure vessel 3 to balance the internal pressure and external pressure of the mill body 1, thereby improving the stress environment of the mill body 1 so that the mill body 1 may follow the design and production requirements of the general level, greatly reducing the research and development and manufacturing costs; at the same time, by designing the pressure of the inert media filled in the high-pressure vessel 3 to be slightly larger than the internal pressure of the mill body 1, the mill body 1 thus operates under pressure, thus reducing the dust leakage and flying dust phenomenon, and reducing the environmental dust pollution; moreover, by adding a cushion pad 7 between the mill body 1 and the supporting base 6 and connecting both the feeding pipe and the discharging pipe of the mill body 1 with the feeding port and the discharging port of the high-pressure vessel 3 by a soft joint, the mill body 1 and the high-pressure vessel 3 are all softly connected, so that it is possible to effectively prevent the vibration of the mill body 1 from being transferred to the high-pressure vessel 3, thereby improving the stability and service life of the high-pressure vessel 3.

The lower end of the connecting shaft 8 is connected to the main shaft of the mill body 1 through a coupling 9. Of course, the main shaft of the mill body 1 may also be lengthened and extended outside the high-pressure vessel 3 to be in a direct transmission connection with the output shaft of the motor 2.

The base portion of the supporting base 6 is located within the high-pressure vessel 3, and the leg portion of the supporting base 6 runs through the bottom of the high-pressure vessel 3 in a sealing manner and extends to align with the leg of the high-pressure vessel 3. By penetrating the leg portion of the supporting base 6 through the bottom of the high-pressure vessel 3 in a sealing manner and extending to align with the leg of the high-pressure vessel 3, this greatly reduces the stress of the leg of the high-pressure vessel 3, thereby further improving the stability and service life of the high-pressure vessel 3. The leg portion of the supporting base 6 runs through the bottom of the high-pressure vessel 3 with a bellows 10 in a sealing manner. Of course, other sealing structures may also be used.

The mill body 1 comprises a shell 1a and an upper-layer crushing mechanism 1b and a lower-layer milling mechanism 1c disposed in the shell 1a, respectively;

the upper-layer crushing mechanism 1b comprises an upper-layer wear-resistant lining ring 1b1, a plurality of upper-layer rotating discs 1b2 sequentially decreasing in diameter from the top down are laminated in the upper-layer wear-resistant lining ring 1b1, a groove 1b5 for receiving a stepped structure of the upper-layer rotating discs 1b2 is provided on the inner surface of the upper-layer wear-resistant lining ring 1b1, the diameter of the groove 1b from the top down in each layer corresponds to a diameter of the upper-layer rotating disc 1b2 at the corresponding position, a plurality of upper-layer guide grooves 1b3 are provided corresponding to an outer edge of each of the upper-layer rotating discs 1b2, a corresponding number of upper-layer milling bodies 1b4 are installed movably between adjacent two of the upper-layer rotating discs 1b2 through the guide grooves 1b3, the masses of all the upper-layer milling bodies 1b4 on the upper-layer rotating discs 1b2 are sequentially decreased layer by layer from the top down, and the masses of the upper-layer milling bodies 1b4 on one upper-layer rotating disc 1b2 are the same;

the lower-layer milling mechanism 1c comprises a lower-layer wear-resistant lining ring 1d, a plurality of lower-layer rotating discs 1c2 having the same diameter are laminated in the lower-layer wear-resistant lining ring 1c1, a plurality of lower-layer guide grooves 1c3 are provided corresponding to an outer edge of each of the lower-layer rotating discs 1c2, respectively, a corresponding number of lower-layer milling bodies 1c4 are installed movably between two adjacent lower-layer rotating discs 1c2 through the lower-layer guide grooves 1c3, the masses of all the lower-layer milling bodies 1c4 the same;

the upper-layer wear-resistant lining ring 1b1 and the lower-layer wear-resistant lining ring 1c1 are fixedly installed on the inner walls of the upper half and the lower half of the shell 1a, respectively, the upper-layer rotating disc 1b2 and the lower-layer rotating disc 1c2 are fixedly installed on the main shaft of the mill body 1, respectively, the upper-layer rotating disc 1b2 and the lower-layer rotating disc 1c2 at the bottom layer have the same diameter, and the mass of the upper-layer milling body 1b4 at the bottom layer is the same as the mass of the lower-layer milling body 1c4.

In actual operation, the milling body moves outward along the guide groove on the rotating disc under the action of a centrifugal force until it presses against the inner surface of the wear-resistant lining ring. At this point, the milling body makes an auto-rotation while making a revolution with respect to the main shaft of the mill body 1 along with the rotation of the main shaft of the mill body 1 in order to crush and mill the material.

By designing the upper and lower parts of the mill body 1 correspondingly as a material crushing area and a material milling area, respectively, the crushing and milling functions are integrated and the milling process is simplified; at the same time, the milling body 1 has a vertical multi-layer layout, the milling body is large in mass at the upper part thereof and mainly has an impact effect on the material, so that a bulky material may be quickly crushed under the effect of the impact of the large-mass milling body, the milling body is small in mass and large in quantity at the lower part thereof, the material which has been impacted and crushed by the large-mass milling body in the upper layer is mainly subjected to rolling, abrasion and micro impact when passing through the material milling area of the small-mass milling body so that the material may be effectively milled to an appropriate particle size so as to achieve the requirement of a certain particle size without a sorting mechanism; moreover, by replacing the upper-layer milling body 1b4 and the lower-layer milling body 1c4 of different masses, the particle size of the finished milled product may be adjusted, which is easy to operate, convenient and fast; moreover, the milling body in the mill body 1 is large in quantity and small in mass so that the milling body has a small impact on the shell 1a, thereby reducing the vibration and noise of the mill body 1; moreover, the groove 1b5 of a stepped structure may effectively delay the falling speed of the material in the crushing zone, increasing the residence time of the material in the crushing zone, thus contributing to increasing the chance that the material is crushed and milled; finally, by designing the diameter of the upper-layer rotating disc at the bottom layer to be the same as the diameter of the lower-layer rotating disc and designing the mass of the upper-layer milling body at the bottom layer to be the same as the mass of the lower-layer milling body, the material can smoothly transfer from the material crushing area to the material milling area well.

The top and bottom of the shell 1a are correspondingly provided with an upper bearing seat 1d and a lower bearing seat 1e, respectively, the upper end of the main shaft of the mill body 1 is installed in the upper bearing seat 1d through a planar thrust bearing 1f, and the lower end of the main shaft of the mill body 1 is installed in the lower bearing seat 1e through a cylindrical roller self-aligning bearing 1g. By designing the bearing at the upper end of the main shaft of the mill body 1 as a planar thrust bearing 1f, the planar thrust bearing 1f may provide an axial force for the main shaft of the mill body 1 very well, and by designing the bearing at the lower end of the main shaft of the mill body 1 as a cylindrical roller self-aligning bearing 1g, the cylindrical miler self-aligning bearing 1g may effectively prevent excessive deflection of the main shaft. Thus, the combination of the planar thrust bearing 1f and the cylindrical roller self-aligning bearing 1g improves the working condition of the main shaft of the mill body 1, so that the stiffness and the strength of the main shaft of the mill body 1 are guaranteed. The upper end of the main shaft of the mill body 1 is also installed in the upper bearing seat 1d through a cylindrical roller bearing 1h which is located above the planar thrust bearing 1f. By adding a cylindrical roller bearing 1h above the planar thrust bearing 1f, the cylindrical roller bearing 1h forms a three-bearing static determinate support with the plane thrust bearing 1f and the cylindrical miller self-aligning bearing 1g, thereby further improving the working condition of the main shaft of the mill body 1, so that the stiffness and the strength of the main shaft of the mill body 1 are guaranteed better.

A cooler 11 is provided outside the shell 1a, and the cooler 11 is a condenser. By adding a cooler 11 outside the shell 1a, the operating temperature of the mill body 1 may be greatly reduced, so that the operating temperature of the mill body 1 may be controlled within a reasonable temperature range to ensure the optimum working state of the mill body 1. In actual production, cold gas or cold liquid may pass through a condensing tube. The side wall of the high-pressure vessel 3 is provided with a service port 12. The added service port 12 can facilitate the service and maintenance in the latter period. The high-pressure vessel 3 is sealed and assembled by the upper high-pressure vessel section 3e and the lower high-pressure vessel section 3d. By designing the high-pressure vessel 3 as an assembled structure, this, on the one hand, reduces the difficulty of production of the high-pressure vessel 3, and, on the other hand, facilitates the installation and maintenance of the mill body 1.

The milling process of the mill of the present disclosure is as follows.

The material enters the mill body 1 from the feeding port 3a. The material enters the material crushing area first and is impacted and crushed by the upper-layer milling body 1b4 in the process of falling in the mill body 1. After passing through the section of the material crushing area, the material will be crushed into tiny particles of a certain size. These tiny particles continue to fall under the action of gravity, and thus enter the material milling area to be milled and abraded by the lower-upper milling body 1c4. After passing through the section of the material milling area, the material will be milled to a particle size, and are finally discharged from the discharging port 3b to complete the milling process.

In the present disclosure, by disposing a high-pressure vessel 3 outside the mill body 1, a high-pressure inert medium may be filled in the sealing space between the mill body 1 and the high-pressure vessel 3 to balance the internal pressure and external pressure of the mill body 1, thereby improving the stress environment of the mill body 1 so that the mill body 1 may follow the design and production requirements of the general level, greatly reducing the research and development and manufacturing costs; by designing the pressure of the inert media filled in the high-pressure vessel 3 to be slightly larger than the internal pressure of the mill body 1, the mill body 1 thus operates under pressure, thus reducing the dust leakage and flying dust phenomenon, and reducing the environmental dust pollution; by adding a cushion pad 7 between the mill body 1 and the supporting base 6 and connecting both the feeding pipe and the discharging pipe of the mill body 1 with the feeding port and the discharging port of the high-pressure vessel 3 by a soft joint, the mill body 1 and the high-pressure vessel 3 are all softly connected, so that it is possible to effectively prevent the vibration of the mill body 1 from being transferred to the high-pressure vessel 3, thereby improving the stability and service life of the high-pressure vessel 3; by penetrating the leg portion of the supporting base 6 through the bottom of the high-pressure vessel 3 in a sealing manner and extending to align with the leg of the high-pressure vessel 3, this greatly reduces the stress of the leg of the high-pressure vessel 3, thereby further improving the stability and service life of the high-pressure vessel 3; by designing the upper and lower parts of the mill body 1 correspondingly as a material crushing area and a material milling area, respectively, the crushing and milling functions are integrated and the milling process is simplified; the milling body 1 has a vertical multi-layer layout, the milling body is large in mass at the upper part thereof and mainly has an impact effect on the material, so that a bulky material may be quickly crushed under the effect of the impact of the large-mass milling body, the milling body is small in mass and large in quantity at the lower part thereof, the material which has been impacted and crushed by the large-mass milling body in the upper layer is mainly subjected to rolling, abrasion and micro impact when passing through the material milling area of the small-mass milling body so that the material may be effectively milled to an appropriate particle size so as to achieve the requirement of a certain particle size without a sorting mechanism; by replacing the upper-layer milling body 1b4 and the lower-layer milling body 1c4 of different masses, the particle size of the finished milled product may be adjusted, which is easy to operate, convenient and fast; the milling body in the mill body 1 is large in quantity and small in mass so that the milling body has a small impact on the shell 1a, thereby reducing the vibration and noise of the mill body 1; the groove 1b5 of a stepped structure may effectively delay the falling speed of the material in the crushing zone, increasing the residence time of the material in the crushing zone, thus contributing to increasing the chance that the material is crushed and milled; by designing the diameter of the upper-layer rotating disc at the bottom layer to be the same as the diameter of the lower-layer rotating disc and designing the mass of the upper-layer milling body at the bottom layer to be the same as the mass of the lower-layer milling body, the material can smoothly transfer from the material crushing area to the material milling area well; by designing the bearing at the upper end of the main shaft of the mill body 1 as a planar thrust bearing 1f, the planar thrust bearing 1f may provide an axial force for the main shaft of the mill body 1 very well, and by designing the bearing at the lower end of the main shaft of the mill body 1 as a cylindrical roller self-aligning bearing 1g, the cylindrical roller self-aligning bearing 1g may effectively prevent excessive deflection of the main shaft. Thus, the combination of the planar thrust bearing 1f and the cylindrical roller self-aligning bearing 1g improves the working condition of the main shaft of the mill body 1, so that the stiffness and the strength of the main shaft of the mill body 1 are guaranteed; by adding a cylindrical roller bearing 1h above the planar thrust bearing 1f, the cylindrical roller bearing 1h forms a three-bearing static determinate support with the plane thrust bearing 1f and the cylindrical roller self-aligning bearing 1g, thereby further improving the working condition of the main shaft of the mill body 1, so that the stiffness and the strength of the main shaft of the mill body 1 are guaranteed better, by adding a cooler 11 outside the shell 1a, the operating temperature of the mill body 1 may be greatly reduced, so that the operating temperature of the mill body 1 may be controlled within a reasonable temperature range to ensure the optimum working state of the mill body 1; the added service port 12 can facilitate the service and maintenance in the latter period; by designing the high-pressure vessel 3 as an assembled structure, this, on the one hand, reduces the difficulty of production of the high-pressure vessel 3, and, on the other hand, facilitates the installation and maintenance of the mill body 1.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A mill, comprising:
a mill body comprising a feeding pipe and a discharging pipe;
a motor; and
a vessel comprising a feeding port, a discharging port, and a supporting base; wherein
the vessel is disposed outside the mill body, and a sealing space is formed between the vessel and the mill body;
the feeding port is disposed on an outer wall of an upper part of the vessel and in a seal-tight connection with the feeding pipe of the mill body through a soft feeding joint, and the discharging port is disposed on an outer wall of a lower part of the vessel and is in a seal-tight connection with the discharging pipe of the mill body through a soft discharging joint;
the supporting base is disposed at a bottom of the vessel, and the mill body is installed on the supporting base via a cushion pad;
a connecting shaft is inserted movably at a top of the vessel in a sealing manner, an upper end of the connecting shaft is in a transmission connection with an output shaft of the motor, and a lower end of the connecting shaft is connected with a main shaft of the mill body;
in use, the sealing space between the mill body and the vessel is filled with an inert medium, and a pressure of the inert medium is greater than or equal to a pressure in the mill body.

2. The mill of claim 1, wherein the lower end of the connecting shaft is connected to the main shaft of the mill body via a coupling.

3. The mill of claim 1, wherein the supporting base comprises a base portion and a leg portion; the base portion of the supporting base is located within the vessel, and the leg portion of the supporting base runs through the bottom of the vessel in a sealing manner and extends to align with legs of the vessel.

4. The mill of claim 3, wherein the leg portion of the supporting base runs through the bottom of the vessel via a bellows in a sealing manner.

5. The mill of claim 1, wherein
the mill body comprises a shell, and an upper-layer crushing mechanism and a lower-layer milling mechanism disposed in the shell;
the upper-layer crushing mechanism comprises an upper-layer wear-resistant lining ring, and a plurality of upper-layer rotating discs sequentially decreasing in diameter from the top down are laminated in the upper-layer wear-resistant lining ring; a groove for receiving a stepped structure of the upper-layer rotating discs is provided on an inner surface of the upper-layer wear-resistant lining ring, and a diameter of the groove from the top down in each layer corresponds to a diameter of an upper-layer rotating disc at a corresponding position; a plurality of upper-layer guide grooves are provided corresponding to an outer edge of each of the upper-layer rotating discs, a corresponding number of upper-layer milling bodies are installed movably between two adjacent upper-layer rotating discs through the guide grooves, masses of the upper-layer milling bodies on the upper-layer rotating discs are sequentially decreased layer by layer from the top down, and the masses of the upper-layer milling bodies on one upper-layer rotating disc are the same;
the lower-layer milling mechanism comprises a lower-layer wear-resistant lining ring, a plurality of lower-layer rotating discs having the same diameter are laminated in the lower-layer wear-resistant lining ring, a plurality of lower-layer guide grooves are provided corresponding to an outer edge of each of the lower-layer rotating discs, respectively, a corresponding number of lower-layer milling bodies are installed movably between two adjacent lower-layer rotating discs through the lower-layer guide grooves, and the masses of the lower-layer milling bodies the same; and
the upper-layer wear-resistant lining ring and the lower-layer wear-resistant lining ring are fixedly installed on inner walls of an upper half and a lower half of the shell, respectively, and the upper-layer rotating disc and the lower-layer rotating disc are fixedly installed on the main shaft of the mill body.

6. The mill of claim 5, wherein the upper-layer rotating disc at a lowest layer and the lower-layer rotating disc have the same diameter, and the mass of the upper-layer milling body at a lowest layer is the same as the mass of the lower-layer milling body.

7. The mill of claim 5, wherein a top and a bottom of the shell are correspondingly provided with an upper bearing seat and a lower bearing seat, respectively, an upper end of the main shaft of the mill body is installed in the upper bearing seat through a planar thrust bearing, and a lower end of the main shaft of the mill body is installed in the lower bearing seat through a cylindrical roller self-aligning bearing.

8. The mill of claim 7, wherein the upper end of the main shaft of the mill body is installed in the upper bearing seat through a cylindrical roller bearing which is located above the planar thrust bearing.

9. The mill of claim 5, wherein a cooler is provided outside the shell, and the cooler is a condenser.

10. The mill of claim 1, wherein a side wall of the vessel is provided with a service port.

11. The mill of claim 1, wherein the vessel comprises an upper section and a lower section which are assembled in seal.
